(19) United States
(12) Patent Application Publication
(10) Pub. No.: US 2025/0050298 A1
(43) Pub. Date: Feb. 13, 2025

(54) FORMING CORE-SHELL MICROCAPSULES

(71) Applicant: Saudi Arabian Oil Company, Dhahran (SA)

(72) Inventors: Maxim Orlov, Moscow (RU); Vyacheslav Grokhovsky, Moscow (RU); Abdullah Saleh Hussain Al-Yami, Dhahran (SA)

(21) Appl. No.: 18/717,993

(22) PCT Filed: Dec. 14, 2021
(86) PCT No.: PCT/RU2021/000568

§ 371 Date: Jun. 7, 2024

(51) Int. Cl. B01J 13/04

(52) U.S. Cl. CPC B01J 13/04

(57) ABSTRACT

Some microcapsule forming systems include a first container containing a core material; a second container containing a shell material; one or more heaters in mechanical contact with the first and second containers; a first pair of syringe pumps operable to pump the heated core material from the first container to an encapsulation cell; a second pair of syringe pumps operable to pump the heated shell material from the first container to the encapsulation cell; a controller for controlling the one or more heaters and the first and second pair of syringe pumps; the encapsulation cell comprising a first nozzle disposed concentrically within a second nozzle, the first nozzle operable to form a sphere using the heated and pumped core material and the second nozzle operable to form a shell surrounding the sphere using the heated and pumped shell material to form a microcapsule.

### TECHNICAL FIELD

This disclosure describes systems and methods for forming core-shell micron-sized capsules (“microcapsules”), and in particular, forming core-shell microcapsules using heated materials.

### BACKGROUND

Microcapsules are used in geophysics for lost circulation prevention and enhanced oil recovery. Microcapsules can be deployed into a reservoir which later dissolve to release active material into a reservoir. In some examples, the active material can be a surfactant that improves geological formation wettability to recover more oil from the reservoir. Generally, microcapsules have been used as micro-carriers and have become one of the emerging active material delivery technologies due to being targeted, having controlled release, having stability, and being able to modify surfaces of geological formations.

The microcapsules are formed using an encapsulation process. Some encapsulation processes include interfacial and in-situ polymerization, complex coacervation, spray drying, phase inversion, and fluidized-bed coating (for example, the Wurster process).

### SUMMARY

The microcapsule formation systems described in this disclosure form core-shell microcapsules having an outer diameter of less than 1 millimeter using heated, and in some cases, melted materials. The microcapsule formation systems are computer controlled to maintain a particular temperature of materials and a particular volumetric flow rate of the materials throughout the entire microcapsule formation process. The volumetric flow rate is maintained using an alternating pumping sequence of syringe pumps. These syringe pumps pump high temperature materials (for example, up to 250° C.). For example, the microcapsule formation systems form core-shell microcapsules having a plastic outer shell with a liquid surfactant inside the shell.

Some systems for microcapsule formation include a first container containing a core material and a second container containing a shell material. Some systems include one or more container heaters in mechanical contact with the first and second containers. In some systems, the one or more container heaters are operable to heat the core and shell materials to a temperature between 0° C. and 250° C. Some systems include a first pair of syringe pumps operable to pump the heated core material from the first container to an encapsulation cell at a first volumetric rate and a first pressure by alternating the pumping between each syringe pump of the first pair of syringe pumps. Some systems include a second pair of syringe pumps operable to pump the heated shell material from the first container to the encapsulation cell at a second volumetric rate and a second pressure by alternating the pumping between each syringe pump of the second pair of syringe pumps. Some systems include one or more syringe heaters in mechanical contact with the first and second pairs of syringe pumps. In some systems, the one or more heaters are operable to heat the core and shell materials while the core and shell materials are pumped by the syringe pumps. Some systems include a vibration source operable to vibrate the encapsulation cell. In some systems, the encapsulation cell includes an inner nozzle concentrically disposed within an outer nozzle. In some systems, the inner and outer nozzles are operable to form a microcapsule using the core material and the shell material while the encapsulation cell is vibrated by the vibration source. Some systems include a processor operable to control the one or more container heaters, the first and second pair of syringe pumps, and the vibration source.

In some systems, the processor is operable to control the one or more container heaters and the one or more syringe heaters to heat the shell material to a temperature between 120° C.-150° C. In some cases, the processor is operable to control the one or more container heaters and the one or more syringe heaters to heat the core material to a temperature between 50-70% of the temperature of the shell material.

In some systems, the one or more syringe heaters include temperature controlled casings.

In some systems, the processor is operable to control the first and second volumetric rates to be between 200 microliters/minute and 50 milliliters/minute.

In some systems, the processor is operable to maintain the first and second volumetric rates within a 100 microliters/minute error band.

In some systems, the processor is operable to control the first and second pressures to be between 1 to 20 atm.

In some systems, at least one of the core material and the shell material is in a melted state. In some cases, the first and second pairs of syringe pumps are operable to pump the melted material. In some cases, the melted materials includes at least one of a polymer; a lipids, a wax, a surfactant, and a surface stabilizing agent.

In some systems, the vibration source includes a membrane and a magnet for generating vibration. In some cases, the processor is operable to control a vibration frequency of the vibration source to be between 50 Hz and 10 kHz.

In some systems, the formed microcapsule has an outer diameter between 1 micrometers and 10 micrometers.

Some methods for forming a microcapsule include heating, by one or more container heaters, a core material within a first container and a shell material within a second container to a temperature between 0° C. and 250° C. Some methods include pumping, by a first pair of syringe pumps, the heated core material from the first container to an encapsulation cell at a first volumetric rate by alternating the pumping between each syringe pump of the first pair of syringe pumps. Some methods include pumping, by a second pair of syringe pumps, the heated shell material from the second container to the encapsulation cell at a second volumetric rate by alternating the pumping between each syringe pump of the second pair of syringe pumps. Some methods include heating, by one or more syringe heaters, the core and shell materials while pumping the heated core and shell materials from the first container to the encapsulation cell. Some methods include vibrating, by a vibration source, the encapsulation cell. Some methods include forming, by first and second nozzles of the encapsulation cell, a microcapsule using the heated core material and the heated shell material while vibrating the encapsulation cell. In some methods, the first nozzle is disposed concentrically within the second nozzle. In some methods, the microcapsule has an inner core of the heated core material and an outer shell of the heated shell material. Some methods include controlling, by a processor, the first volumetric rate and the second volumetric rate.

In some methods, heating the shell material within the first container and heating the shell material while pumping includes heating the core material to a temperature between 120° C.-150° C. In some cases, heating the core material within the first container and heating the core material while pumping includes heating the core material to a temperature between 50-70% of the temperature of the shell material.

In some methods, heating the core material within the first container and the shell material within the second container to the temperature between 0° C. and 250° C. includes melting at least one of the core and shell materials.

Some methods include controlling a volumetric rate the first pair and the second pair of syringe pumps. Some methods include maintaining the volumetric rate within an error band while forming the microcapsule.

Some methods include controlling the first and second volumetric rates to be between 200 microliters/minute and 50 milliliters/minute.

Some methods include controlling a pressure of the first pair of syringe pumps to be between 1 to 20 atm and controlling a pressure of the second pair of syringe pumps to be between 1 to 20 atm.

Some methods include controlling, by the processor, a vibration frequency of the vibration source to be between 50 Hz and 10 KHz.

The systems and methods described in this disclosure provide various advantages.

The computer control of the microcapsule formation systems described in this disclosure allows microcapsules to be formed quickly and consistently. For example, by alternating the pumping of the syringe pumps (for example, in an anti-phase manner using pairs of syringe pumps), the volumetric flow rate can be controlled and maintained. This controlled and maintained volumetric flow rate allows microcapsules to be formed quickly and consistently.

The computer controls all aspects of the formation process such as the volumetric flow rate, the pressure within the pumps, the temperature of the materials, and the vibration associated with breaking up laminar streams of composite material during the formation process.

Including heaters at various stages of the microcapsule formation process (for example, at the storage containers, at each of the fluid lines, at the syringe pumps, and at the encapsulation cell), allows the temperature to be maintained for temperature and viscosity consistency throughout the entire formation process.

The syringe pumps described herein are operable at temperatures up to 250° C. which allows temperatures up to 250° C. to be maintained throughout the entire formation process. Controlling and maintaining these high temperatures enable the process to form microcapsules using melted materials such as plastic quickly and consistently.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is an illustration of a microcapsule formation system.

FIG. 2 is a schematic of a microcapsule formation process.

FIG. 3 is a method for forming microcapsules.

FIG. 4 is a schematic of a computer system for controlling microcapsule formation systems.

Like reference symbols in the various drawings indicate like elements.

### DETAILED DESCRIPTION

The microcapsule formation systems described in this disclosure form core-shell microcapsules having an outer diameter of less than 1 millimeter using heated, and in some cases, melted materials. The microcapsule formation systems are computer controlled to maintain a particular temperature of materials and a particular volumetric flow rate of the materials throughout the entire microcapsule formation process. The volumetric flow rate is maintained using an alternating pumping sequence of syringe pumps. These syringe pumps pump high temperature materials (for example, up to 250° C.). For example, the microcapsule formation systems form core-shell microcapsules having a plastic outer shell with a liquid surfactant inside the shell.

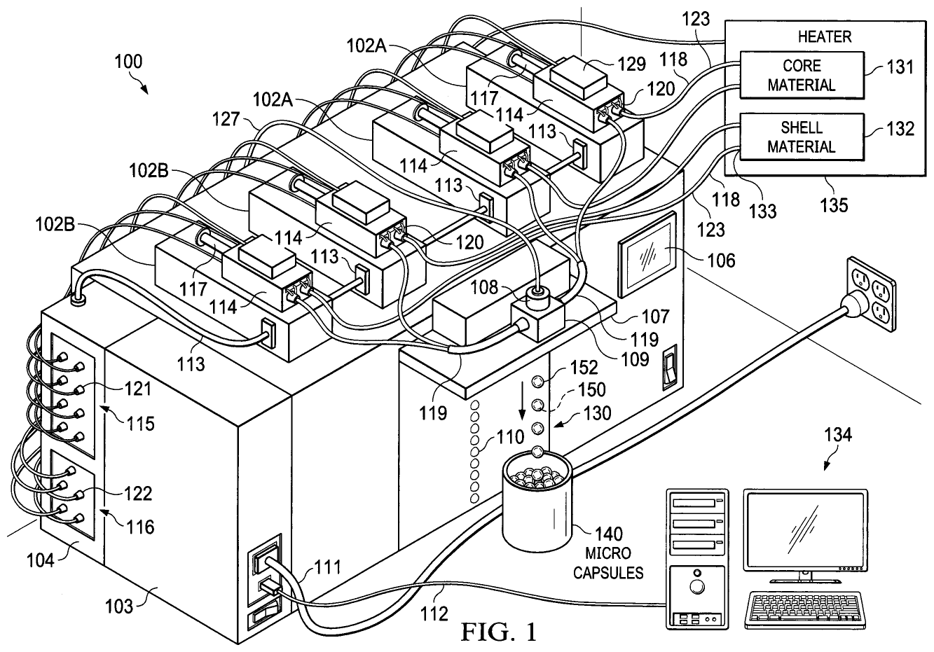

FIG. 1 is an illustration of a microcapsule formation system 100. The microcapsule formation system 100 includes an encapsulator machine 101 that houses various components of the microcapsule formation system 100. The encapsulator machine 101 includes a power supply 103, a control system 104, syringe pumps 102A, 102B, heaters 114, an encapsulation cell 109, a vibration source 108, a heat plate 107, a light source 110, and a user interface 106. The encapsulator machine 101 receives electrical power from a power cable 111 that connects to a wall outlet (for example, a 120V wall outlet). The encapsulator machine 101 is computer controlled using a computer 134 and the control system 104.

The computer 134 implements software that allows a user to define material flow rates, material temperatures, flow pressures, light illumination, vibration frequency, and vibration amplitude of the microcapsule formation system 100. The software communicates with the control system 104 using a cable 112 (for example, a USB cable or Ethernet cable). The user interface 106 performs the same functionality as the computer 134 but is mounted directly on the housing of the encapsulator machine 101. A user interacts with the microcapsule formation system 100 using either the computer 134 or the user interface 106.

The control system 104 includes a first set of connectors 121 (for example, BNC connectors) and a second set of connectors 122 (also, for example, BNC connectors). The control system 104 sends electrical power and control signals (for example, vibration control signals, temperature control signals, illumination control signals) to the electrical components of the microcapsule formation system 100 using wires 105 connected to the first set of connectors 121. The control system 104 receives feedback signals (for example, vibration measurements, temperature measurements) using wires 116 connected to the second set of connectors 122.

For example, the control system 104 sends electrical power and control signals to the syringe pumps 102A, 102B, the syringe heaters 114, the container heater 135, the line heaters 123, the heating plate 107, the vibration source 108, the light source 110, and the user interface 106 using wires 115, and receives vibration measurements from vibration transducers and temperature measurements from thermocouples located throughout the microcapsule formation system 100 using the wires 116.

The microcapsule formation system 100 includes a first container 131 containing a core material and a second container 132 containing a shell material. The containers 131, 132 include one or more ports 133 that connect to fluid lines 118 for withdrawing the materials from the containers 131, 132 (for example, using suction from the syringe pumps 102A, 102B).

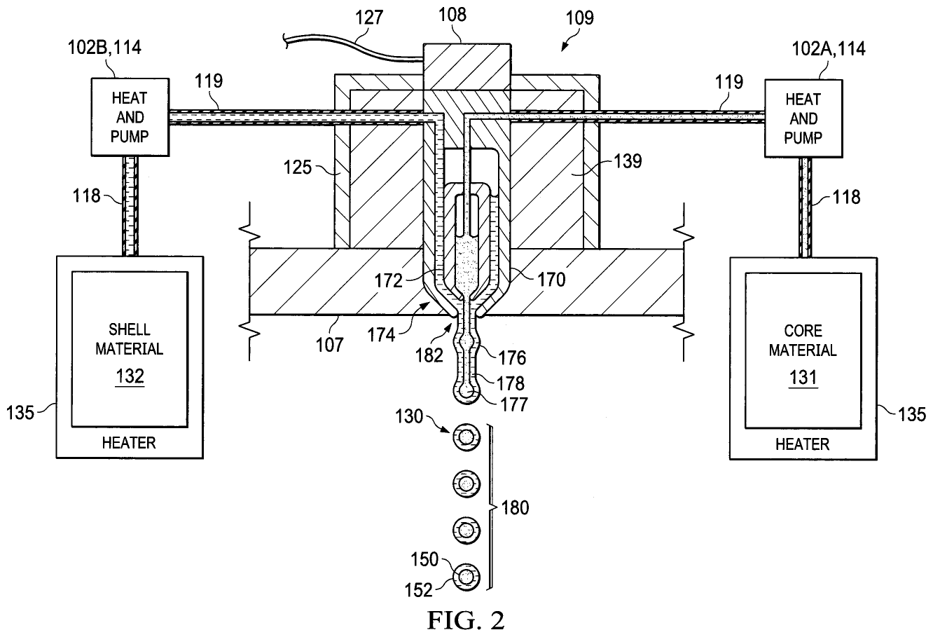

The core and shell materials are pumped and used by the encapsulation cell 109 to form a microcapsule 130. For example, the encapsulation cell 109 forms the microcapsule 130 having an inner core 150 of the core material and an outer shell 152 of the shell material. The outer shell 150 completely surrounds the inner core 150. The process of forming the microcapsule 130 is described with reference to FIG. 2.

The microcapsule formation system 100 includes one or more heaters for heating the core material and the shell material. The one or more heaters include a heating plate 107, syringe heaters 114, a container heater 135, and line heaters 123. The one or more heaters are computer controlled using the control system 104.

The container heater 135 is in thermal and mechanical contact with the first and second containers 131, 132 and is operable to heat the core and shell materials while the materials are within the containers 131, 132. In some examples, the container heater 135 includes a first heater surrounding the first container 131 and a second heater surrounding the second container 132. In such an example, the control system 104 controls the temperature of each container heater individually. In some examples, the container heater 135 is a thermal jacket.

The syringe heaters 114 are in thermal and mechanical contact with the syringe pumps 102A, 102B and are operable to heat the core and shell materials while the materials are being pumped by the syringe pumps 102A, 102B. The microcapsule formation system 100 includes four syringe heaters 114. Two of the syringe heaters 114 are used to heat the core material and two of the syringe heaters 114 are used to heat the shell material. The syringe heaters 114 include a heating jacket and a thermocouple. In some examples, the syringe pumps 102A, 102B include temperature controlled casings for working with melted materials. For example, the control system 104 controls the temperature of the casing of the syringe pumps 102A, 102B based on a desired temperature of the core and/or shell materials.

The heating plate 107 is in thermal and mechanical contact with the encapsulation cell 109 and is operable to heat the core and shell materials while the materials are within the encapsulation cell 109. For example, the heating plate 107 heats the materials while the encapsulation cell 109 forms the microcapsule 130.

The line heaters 123 surround the fluid lines 118 and the fluid lines 119. In some examples, the line heaters 123 include heating tape. Electrical connections 120 communicate power from the power supply 103 to the line heaters 123. The electrical connections 120 also communicate temperature measurements from the line heaters to the control system 104. The linear heaters 123 include thermocouples disposed along the fluid lines 118, 119. In some examples, the line heaters 123 include a jacket that surrounds the fluid lines 118, 119 and spans an entire length of the fluid lines 118, 119. In some examples, the jacket is a thermally insulating material to reduce the heat loss of the core and shell materials within the fluid lines 118, 119. Reducing the heat loss also reduces the likelihood that melted core and shell materials harden within the fluid lines 118, 119.

In most cases, all of the heaters of the microcapsule formation system 100 are computer-controlled by the control system 104 and the computer 134. This temperature control allows for independent control of each the core material temperature and the shell material temperature. This temperature control also allows for the temperature of each material to be maintained throughout the microcapsule formation process. For example, the control system 104 controls the temperature from the containers 131, 132, though the fluid lines 118, within the syringe pumps 102A, 102B, within the fluid lines 119, and within the encapsulation cell 109 as the microcapsules 130 are formed using any and/or all of the heaters of the microcapsule formation system 100.

While all of the heaters of the microcapsule formation system 100 can be controlled by the control system 104, some of the heaters can be passive. For example, in some examples, the line heaters 123 are thermal jackets that are not actively controlled.

In some examples, the control system 104 controls the core material temperature and the shell material temperature to be between 0° C. and 250° C. (for example, between 100° C. and 250° C. or between 200° C. and 250° C.). In some examples, the control system 104 actively controls either or both of these temperatures within a 5° C. deviation. For example, if the desired temperature of the core material is 210° C. and the desired temperature of the shell material is 150° C. (for example, as defined by a user of the computer 134 or user interface 106), then the control system 104 controls the temperature of the core material to be between 205° C. and 215° C. and controls the temperature of the shell material to be between 145° C. and 155° C.

In some examples, the control system 104 controls the shell material temperature to be between 120° C. and 150° C. In some examples, the control system 104 controls the core material temperature to be approximately 50-70% of the temperature of the shell material. For example, if the desired shell material temperature is 135° C., then the desired core material temperature is between 67.5° C. and 94.5° C. (50-70% of 135° C.). In some examples, the specific percentage used is based on the core material and/or the shell material. Heating the core material to approximately 50-70% of the shell material temperature provides stability of the microcapsule formation system 100 and helps to reduce the likelihood of temperature gradients developing within the cell 109 using the concentric nozzles 170, 172 (as described with reference to FIG. 2).

In some examples, the control system 104 controls the temperatures of the core and shell materials to be equal to a melting point of the respective materials. In some examples, the control system 104 controls the core and shell material temperatures to be between 10% lower than the melting point of the respective material and 10% higher than the melting point of the respective material. In some examples, the control system 104 controls the core and shell material temperatures to be between 15% lower than the melting point of the respective material and 15% higher than the melting point of the respective material.

In a typical example, the microcapsule formation system 100 heats the core material temperature to a first temperature while the core material is within the container 131 and maintains the temperature of the core material until core material is used to form the microcapsule 130. Simultaneously, the microcapsule formation system 100 heats the shell material temperature to a second temperature while the shell material is within the container 132 and maintains the temperature of the shell material until the shell material is used to form the microcapsule 130.

The microcapsule formation system 100 includes a first pair of syringe pumps 102A and a second pair of syringe pumps 102B. Each pair of syringe pumps 102A, 102B includes two syringe pumps so the microcapsule formation system 100 as shown in FIG. 1 includes four syringe pumps. The first pair of syringe pumps 102A is operable to pump the heated core material from the first container 131 to the encapsulation cell 109 at a first volumetric rate and a first pressure. The second pair of syringe pumps 102B is operable to pump the heated shell material from the second container 132 to the encapsulation cell 109 at a second volumetric rate and a second pressure.

Each syringe pump includes a syringe 117 disposed within a syringe chamber. The syringes 117 inside syringe heaters 114 are wrapped with a heating wire. The heating wire includes a solenoid that heats the syringe 117 and materials (the core or shell materials). In some examples, the control system 104 controls the solenoid to heat the materials to a predetermined temperature. In some examples, the control system 104 transmits a preferred temperature to a temperature controller 129 and the temperature controller 129 controls the solenoid to heat the materials to the predetermined temperature.

As the syringe 117 slides rearward with respect to the syringe chamber (for example, away from the side of the syringe 117 with the connected lines 118, 119), the heated material (either the core material or the shell material) is siphoned from the containers (either the first container 131 or the second container 132), through the fluid lines 118, and into the syringe chamber. As the syringe 117 slides forward with respect to the syringe chamber (for example, towards the side of the syringe 117 with the connected lines 118, 119), the heated material (either the core material or the shell material) is displaced from the syringe chamber, through the fluid lines 119, and into the encapsulation cell 109. Importantly, the syringe heaters 114 heat the material (either the core material or the shell material) while the material is within the syringe chamber of the syringe pumps 102A, 102B.

In some examples, the temperature is sufficiently high to melt the core and/or the shell materials. For example, controlling the temperature of the container heaters 135 to be above the melting temperature of the material will cause melting of the material. In such cases, the first and second pair of syringe pumps 102A, 102B are operable to pump the melted material. In some examples, the melted material includes at least one of a polymer; a lipids, a wax, a surfactant, and a surface stabilizing agent. In some examples, the shell material is a melted polymeric (for example, plastic) material. In some examples, the plastic is at least one of polyolefins, acrylates, polyesters, polystyrene, and polyamides. In some examples, the core material is a melted material. In some examples, the core material is a phase change material (PCM). For example, a PCM is a substance that releases and/or absorbs energy at phase transition to provide heating and/or cooling. In some examples, the core material one or more of the following active materials: cross-linkers, downhole treatment materials, and oxidizing agents.

All of the syringe pumps 102A, 102B of the microcapsule formation system 100 are computer-controlled by the control system 104. In some examples, the control system 104 individually controls the longitudinal position of each syringe 117 to control the volume within the syringe chamber and a linear velocity of the longitudinal position of each syringe 117 to control the volumetric rate of the syringe pumps 102A, 102B.

In order to control the volumetric rates and pressures of the syringe pumps 102A, 102B, the control system 104 controls each syringe pump of the pair of syringe pumps in an anti-phase manner. For example, the first pair of syringe pumps 102A pumps the heated core material by alternating the pumping between each syringe pump 102A of the first pair of syringe pumps 102A and the second pair of syringe pumps 102B pumps the heated shell material by alternating the pumping between each syringe pump 102B of the second pair of syringe pumps 102B. This alternating pumping enables continuous feeding of the materials to the encapsulation cell 109.

For example, the control system 104 controls the syringe 117 of a first syringe pump of the first pair of syringe pumps 102A to slide rearward to siphon core material into the syringe chamber of the first syringe while simultaneously controlling the syringe 117 of a second syringe pump of the first pair of syringe pumps 102A to slide forward to displace core material from the syringe chamber to the encapsulation cell 109. The encapsulation cell 109 receives a continuous stream of material using this approach.

In some examples, the control system 104 controls the first and second pressures to be between 1 to 20 atm. In some examples, the control system 104 controls the first and second volumetric rates to be between 200 microliters/minute and 50 milliliters/minute. In some examples, the control system 104 maintain the first and second volumetric rates within a 100 microliters/minute deviation.

As shown in FIG. 1, the vibration source 108 is disposed on top of, and in mechanical contact with, the encapsulation cell 109. The vibration source 108 vibrates the encapsulation cell 109 while forming the microcapsules 130 to break up a laminar stream of product produced by the nozzles of encapsulation cell 109. The process of forming the microcapsule is further described with reference to FIG. 2.

In some examples, the vibration source 108 is a vibrator. In some examples, the vibration source 108 includes an elastic membrane and a magnet for generating vibration. In some examples, the vibration source 100 includes an electromagnet. In some examples, the vibration source 100 includes a piezoelectric shaker. In some examples, the control system 104 controls the vibration source 108 to vibration at a vibration frequency between 50 Hz and 10 kHz.

The vibration source 108 is electrically connected to the control system 104 using one or more electrical wires 127. In some examples, the control system 104 controls the vibration source 108 to vibrate at a particular vibration frequency based on the desired diameter of the microspheres 130. In some examples, the control system 104 controls the vibration source 108 to vibrate at a particular vibration frequency based on the diameter of the nozzles 170, 172 which influence the diameter of the microspheres 130. In some examples, the control system 104 controls the vibration source 108 to vibrate at a particular vibration frequency based on the viscosity of the shell and/or core materials. In some examples, the control system 104 controls the vibration source 108 to vibrate at a particular vibration frequency based on the volumetric flow rate of the core and/or shell materials by the syringe pumps 102A, 102B.

In some examples, the control system 104 controls vibration source 108 to vibrate at a particular amplitude. In some examples, the control system 104 controls the vibration source 108 to vibrate according to conditional units from 1 to 9. In some examples, the control system 104 controls the vibration source 108 to vibrate with a particular amplitude between 3 and 5 conditional units. In some examples, higher values of conditional unites (for example, between 5 and 9) are used for viscous materials.

In some examples, the light source 110 is one or more strobe lights. In some examples, the light source is an array of one or more strobe lights as shown in FIG. 1. In some examples, the light source 110 illuminates the formed microcapsules 130 as the formed microcapsule 130 drop from the encapsulation cell 109 after the microcapsules 130 are formed. In some examples, the formed microcapsules 130 fall into a microcapsule container 140.

FIG. 2 is a schematic of a microcapsule formation process and illustrates an example implementation of an encapsulation cell. The encapsulation cell 109 includes a housing 139, a nozzle 170, and a thermal jacket 125 surrounding the housing 139. In some examples, the housing 139 is metal (for example, aluminum or steel). The nozzle 170 produces a laminar stream of composite material 176 to form microcapsules 130. The nozzle 170 includes an inner nozzle 172 disposed concentrically within an outer nozzle 174. The inner nozzle 172 produces a laminar inner stream 177 and the outer nozzle 174 produces a laminar outer stream 178. Together, the inner and outer laminar streams 177, 178 define the laminar stream of composite material 176. The vibration source 108 is in direct contact with the nozzle 170 and vibrates the nozzle 170. This vibration causes the laminar stream of composite material 176 to breakup as illustrated in FIG. 2. The laminar stream of composite material 176 breaks up into a stream 180 of microcapsules 130. In some examples, the diameter of the vibration source 108 equals the diameter of the nozzle 170 as shown in FIG. 2.

In a typical example, the microcapsule formation system 100 uses the inner nozzle 172 to form an inner core 150 (for example, a spherical inner core) of the heated and pumped core material and the outer nozzle 174 to form a shell surrounding the inner core of the heated and pumped shell material. The result of this process is a microcapsule 130 having an inner core 150 of the core material and an outer shell of the shell material. The shell material completely surrounds the inner core material. The microcapsule formation system 100 forms microcapsules 130 having an outer diameter of less than or equal to 1 millimeter. In some examples, the microcapsule formation system 100 forms microcapsules 130 having an outer diameter between 1 micrometer and 1 millimeter. In some examples, the microcapsule formation system 100 forms microcapsules 130 having an outer diameter between 1 micrometer and 10 micrometer.

As shown in FIG. 2, the heating plate 107 is disposed around a portion of the nozzle 170. For example, the heating plate 107 is disposed around a tip of the nozzle 170 where product is discharged. The heating plate 107 is in direct mechanical contact with the nozzle 170 so that thermal energy is transferred from the heating plate 107 to the nozzle 170 (for example, by thermal conduction). The heating plate 107 heats the product as the product is discharged from the nozzle 170. The thermal insulation jacket retains heat inside the encapsulation cell 109. The heating plate 107 includes an opening 182 for the laminar stream of composite material 176 to pass through. The opening 182 is a circular hole in the heating plate 107.

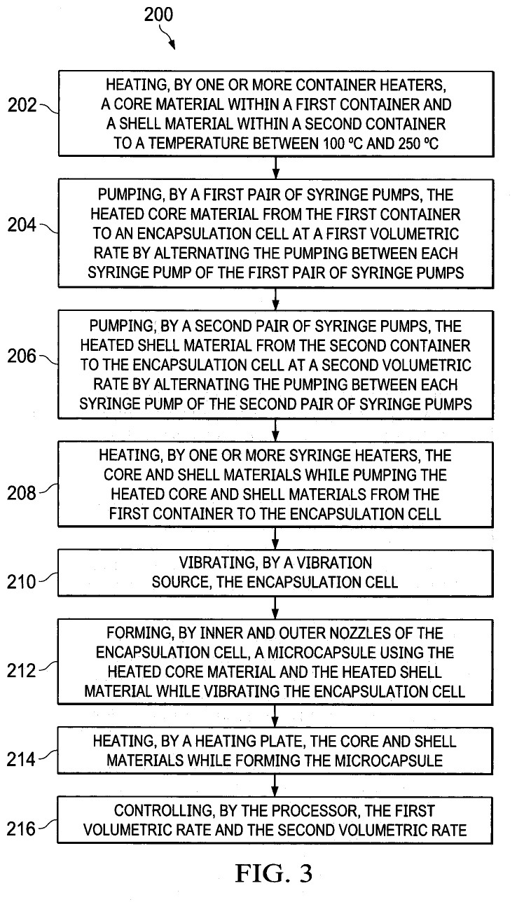

FIG. 3 is a method 200 for forming microcapsules. For example, the computer 134 and the control system 104 implement software to control the microcapsule formation system 100.

At step 202, one or more container heaters heat a core material within a first container and a shell material within a second container to a temperature between 100° C. and 250° C. For example, the container heaters 135 heat the first container 131 containing core material and heat the second container 132 containing shell material. In some examples, the container heaters 135 are two heaters. In some examples, the control system 104 controls the container heaters 135 to achieve a particular temperature (for example, a particular temperature defined by a user using the user interface 106 and/or the computer 134). In some examples, the container heaters 135 heat the core material within the first container 131 at a temperature sufficient to cause the core material to melt. In some examples, the container heaters 135 heat the core material within the first container 132 at a temperature sufficient to cause the shell material to melt.

At step 204, a first pair of syringe pumps pump the heated core material from the first container to an encapsulation cell at a first volumetric rate by alternating the pumping between each syringe pump of the first pair of syringe pumps. For example, the first pair of syringe pumps 102A pump the heated core material from the first container 131 to the encapsulation cell 109 by alternating the pumping between each syringe pump of the first pair of syringe pumps 102A. In some examples, the control system 104 controls each syringe pump of the first pair of syringe pumps 102A to achieve the first volumetric rate.

In some examples, the control system 104 controls the first pair of syringe pumps 102A to achieve a first volumetric rate between 200 microliters/minute and 50 milliliters/minute. In some examples, the control system 104 controls the first pair of syringe pumps 102A to maintain the first volumetric rate within a deviation band. In some examples, the deviation band is between 50 and 150 microliters/minute (for example, 100 microliters/minute). For example, if the control system 104 receives an indication that the desired volumetric rate is 500 microliters/minute and the deviation band is 100 microliters/minute, then the control system 104 controls the first pair of syringe pumps 102A to achieve a first volumetric rate between 400 microliters/minute and 600 microliters/minute.

At step 206, a second pair of syringe pumps pump the heated shell material from the second container to the encapsulation cell at a second volumetric rate by alternating the pumping between each syringe pump of the second pair of syringe pumps. For example, the second pair of syringe pumps 102B pump the heated shell material from the second container 132 to the encapsulation cell 109 by alternating the pumping between each syringe pump of the second pair of syringe pumps 102B. In some examples, the control system 104 controls each syringe pump of the second pair of syringe pumps 102B to achieve the second volumetric rate.

In some examples, the control system 104 controls the second pair of syringe pumps 102A to have a second volumetric rate between 200 microliters/minute and 50 milliliters/minute. This second volumetric rate can be the same as, or different from, the first volumetric rate. In some examples, the control system 104 independently controls the first and second volumetric rates to each be between 200 microliters/minute and 50 milliliters/minute. For example, the control system controls the first pair of syringe pumps 102A to achieve a first volumetric rate of 500 microliters/minute while simultaneously controlling the second pair of syringe pumps 102B to achieve a second volumetric rate of 800 microliters/minute.

In some examples, the control system 104 controls the second pair of syringe pumps 102B to maintain the second volumetric rate within a deviation band. In some examples, the deviation band is between 50 and 150 microliters/minute (for example, 100 microliters/minute). For example, if the control system 104 receives an indication that the desired volumetric rate is 800 microliters/minute and the deviation band is 100 microliters/minute, then the control system 104 controls the second pair of syringe pumps 102B to achieve a second volumetric rate between 700 microliters/minute and 900 microliters/minute.

In some examples, the control system 104 controls a first pressure of the first pair of syringe pumps 102A and/or a pressure of the second pair of syringe pumps 102A to be between 1 to 20 atm. In some examples, the control system 104 independently controls a first pressure of the first pair of syringe pumps and a second pressure of the second pair of syringe pumps.

At step 208, one or more syringe heaters heat the core and shell materials while pumping the heated core and shell materials from the first container to the encapsulation cell. For example, the control system 104 controls the four syringe heaters 114 and the line heaters 123 to heat the core and shell materials. In some examples, the control system 104 controls the syringe heaters 114 and the line heaters 123 to maintain a temperature of the heated core and shell materials.

At step 210, a vibration source vibrates the encapsulation cell. For example, the vibration source 108 vibrates the encapsulation cell 109. In some examples, the control system 104 controls the frequency of the vibration source 108 to be between 40 Hz and 25 kHz.

At step 212, inner and outer nozzles of the encapsulation cell form a microcapsule using the heated core material and the heated shell material while vibrating the encapsulation cell. For example, the core material is ejected from the inner nozzle 172 while the shell material is ejected from the outer nozzle 174 to form a laminar stream of composite material 176. The vibration source 108 vibrates the laminar stream of composite material 176 to break up the laminar stream of composite material 176 into discrete microcapsules 130 having an outer diameter of less than 1 millimeter.

At step 214, a heating plate heats the core and shell materials while forming the microcapsule. For example, the heating plate 107 heats the core and shell materials while the encapsulation cell 109 forms the microcapsule 130.

At step 216, a processor controls the first volumetric rate and the second volumetric rate. For example, one or more processors of the control system 104 control the first and second volumetric rates as described with reference to steps 204 and 206. In some examples, one or more processors control the of the control system 104 control the first and second volumetric rates as described with reference to steps 204 and 206 in addition to the core and shell temperatures as described with reference to step 202.

In some examples, the lights 110 illuminate the formed microcapsule 130 after the encapsulation cell 109 forms the microcapsule 130. In some examples, the control system 104 controls a lights 110 to strobe while the microcapsule 130 falls under the influence of gravity.

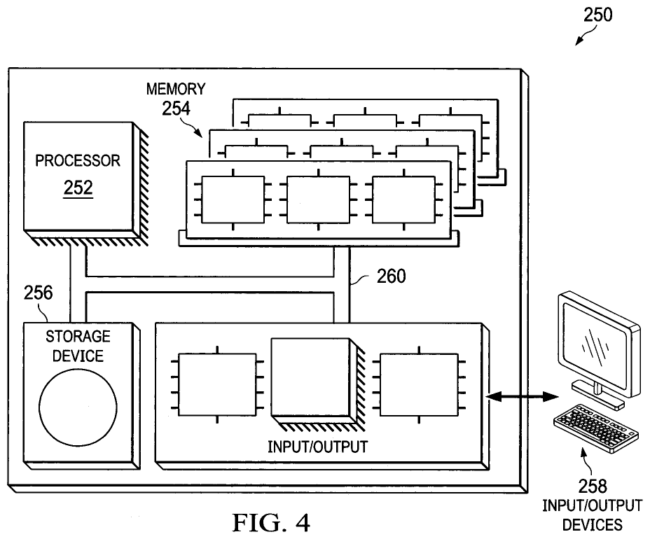

FIG. 4 is a schematic illustration of an example computer 250 for controlling microcapsule formation systems. For example, the computer 250 includes the computer 134 and/or the control system 104 for controlling the microcapsule formation system 100.

The computer 250 is intended to include various forms of digital computers, such as printed circuit boards (PCB), processors, digital circuitry, or otherwise parts of a system for determining a subterranean formation breakdown pressure. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The computer 250 includes a processor 252, a memory 254, a storage device 256, and an input/output device 258 (for example, displays, input devices, sensors, valves, pumps). Each of the components 252, 254, 256, and 258 are interconnected using a system bus 260. The processor 252 is capable of processing instructions for execution within the computer 250. The processor may be designed using any of a number of architectures. For example, the processor 252 may be a CISC (Complex Instruction Set Computers) processor, a RISC (Reduced Instruction Set Computer) processor, or a MISC (Minimal Instruction Set Computer) processor.

In one implementation, the processor 252 is a single-threaded processor. In another implementation, the processor 252 is a multi-threaded processor. The processor 252 is capable of processing instructions stored in the memory 254 or on the storage device 256 to display graphical information for a user interface on the input/output device 258.

The memory 254 stores information within the computer 250. In one implementation, the memory 254 is a computer-readable medium. In one implementation, the memory 254 is a volatile memory unit. In another implementation, the memory 254 is a non-volatile memory unit.

The storage device 256 is capable of providing mass storage for the computer 250. In one implementation, the storage device 256 is a computer-readable medium. In various different implementations, the storage device 256 may be a floppy disk device, a hard disk device, an optical disk device, or a tape device.

The input/output device 258 provides input/output operations for the computer 250. In one implementation, the input/output device 258 includes a keyboard and/or pointing device. In another implementation, the input/output device 258 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A microcapsule formation system comprising:
a first container containing a core material;
a second container containing a shell material;
one or more container heaters in mechanical contact with the first and second containers, the one or more container heaters operable to heat the core and shell materials to a temperature between 0° C. and 250° C.;
a first pair of syringe pumps operable to pump the heated core material from the first container to an encapsulation cell at a first volumetric rate and a first pressure by alternating the pumping between each syringe pump of the first pair of syringe pumps;
a second pair of syringe pumps operable to pump the heated shell material from the first container to the encapsulation cell at a second volumetric rate and a second pressure by alternating the pumping between each syringe pump of the second pair of syringe pumps;
one or more syringe heaters in mechanical contact with the first and second pairs of syringe pumps, the one or more heaters operable to heat the core and shell materials while the core and shell materials are pumped by the syringe pumps;
a vibration source operable to vibrate the encapsulation cell;
the encapsulation cell comprising an inner nozzle concentrically disposed within an outer nozzle, the inner and outer nozzles operable to form a microcapsule using the core material and the shell material while the encapsulation cell is vibrated by the vibration source; and
a processor operable to control the one or more container heaters, the first and second pair of syringe pumps, and the vibration source.

2. The microcapsule formation system of claim 1, wherein the processor is operable to control the one or more container heaters and the one or more syringe heaters to heat the shell material to a temperature between 120° C. and 150° C.

3. The microcapsule formation system of claim 2, wherein the processor is operable to control the one or more container heaters and the one or more syringe heaters to heat the core material to a temperature between 50 and 70% of the temperature of the shell material.

4. The microcapsule formation system of claim 1, wherein the one or more syringe heaters comprise temperature controlled casings.

5. The microcapsule formation system of claim 1, wherein the processor is operable to control the first and second volumetric rates to be between 200 microliters/minute and 50 milliliters/minute.

6. The microcapsule formation system of claim 1, wherein the processor is operable to maintain the first and second volumetric rates within a 100 microliters/minute error band.

7. The microcapsule formation system of claim 1, wherein the processor is operable to control the first and second pressures to be between 1 to 20 atm.

8. The microcapsule formation system of claim 1, wherein at least one of the core material and the shell material is in a melted state.

9. The microcapsule formation system of claim 8, wherein the first and second pairs of syringe pumps are operable to pump the melted material.

10. The microcapsule formation system of claim 8, wherein the melted materials comprises at least one of a polymer; a lipids, a wax, a surfactant, and a surface stabilizing agent.

11. The microcapsule formation system of claim 1, wherein the vibration source comprises a membrane and a magnet for generating vibration and the processor is operable to control a vibration frequency of the vibration source to be between 50 Hz and 10 KHz.

12. The microcapsule formation system of claim 1, wherein the formed microcapsule has an outer diameter between 1 micrometers and 10 micrometers.

13. A method for forming a microcapsule, the method comprising:
heating, by one or more container heaters, a core material within a first container and a shell material within a second container to a temperature between 0° C. and 250° C.;
pumping, by a first pair of syringe pumps, the heated core material from the first container to an encapsulation cell at a first volumetric rate by alternating the pumping between each syringe pump of the first pair of syringe pumps;
pumping, by a second pair of syringe pumps, the heated shell material from the second container to the encapsulation cell at a second volumetric rate by alternating the pumping between each syringe pump of the second pair of syringe pumps;
heating, by one or more syringe heaters, the core and shell materials while pumping the heated core and shell materials from the first container to the encapsulation cell;
vibrating, by a vibration source, the encapsulation cell;
forming, by first and second nozzles of the encapsulation cell, a microcapsule using the heated core material and the heated shell material while vibrating the encapsulation cell, the first nozzle disposed concentrically within the second nozzle, the microcapsule having an inner core of the heated core material and an outer shell of the heated shell material;
controlling, by a processor, a temperature between 0° C. and 250° C. the first volumetric rate and the second volumetric rate.

14. The method of claim 13, wherein heating the shell material within the first container and heating the shell material while pumping comprises heating the core material to a temperature between 120° C. and 150° C.

15. The method of claim 14, wherein heating the core material within the first container and heating the core material while pumping comprises heating the core material to a temperature between 50 and 70% of the temperature of the shell material.

16. The method of claim 13, wherein heating the core material within the first container and the shell material within the second container to the temperature between 0° C. and 250° C. comprises melting at least one of the core and shell materials.

17. The method of claim 13, further comprising:
controlling a volumetric rate the first pair and the second pair of syringe pumps; and
maintaining the volumetric rate within an error band while forming the microcapsule.

18. The method of claim 13, further comprising:
controlling the first and second volumetric rates to be between 200 microliters/minute and 50 milliliters/minute;
controlling a pressure of the first pair of syringe pumps to be between 1 to 20 atm; and
controlling a pressure of the second pair of syringe pumps to be between 1 to 20 atm;

20. The method of claim 13, further comprising controlling, by the processor, a vibration frequency of the vibration source to be between 50 Hz and 10 KHz.
